(19) United States
(12) Patent Application Publication
(10) Pub. No.: US 2005/0049027 A1
(43) Pub. Date: Mar. 3, 2005

(54) Lottery kiosk having game enhancement

(76) Inventor: Steven A. Weiss, Henderson, NV (US)

Correspondence Address: ROY A. EKSTRAND, STE 150, 3158 REDHILL AVE., COSTA MESA, CA, 92626, US

(21) Appl. No.: 10/955,529

(22) Filed: Sep. 30, 2004

Related U.S. Application Data
(63) Continuation of application No. 10/128,599, filed on Apr. 22, 2002, now abandoned.

(51) Int. Cl. A63F 13/00

(52) U.S. Cl. 463/17; 463/42

(57) ABSTRACT

A lottery kiosk includes a stand alone cabinet supporting a display, a plurality of user input buttons, a magnetic card reader, a ticket reader, and a ticket printer. In addition, the stand alone cabinet supports a controller having a microprocessor based control circuit therein. The software within the microprocessor controller contains the appropriate instruction set for facilitating the selection and purchase of lottery tickets. In addition, the controller further includes a game enhancement which is integrated with the lottery ticket purchase system to provide additional entertainment and amusement together with the potential of winning additional credits and lottery tickets.

### CROSS REFERENCE TO RELATED APPLICATION

This application is a continuation of copending application Ser. No. 10/128,599 filed Apr. 22, 2002 on behalf of the inventor of this application and entitled LOTTERY KIOSK HAVING GAME ENHANCEMENT.

### FIELD OF THE INVENTION

This invention relates generally to lotteries and lottery systems and particularly to apparatus used in purchasing and dispensing lottery tickets.

### BACKGROUND OF THE INVENTION

Lotteries, often called “lottos” and the lottery systems which support them are well known and well established in the art. The basic concept of a typical lottery is relatively simple in that various prizes often including cash “jackpots” are offered to the public as part of an extended game of chance. Participants or players enter the lottery and become eligible for winning one or more of the prizes or jackpots by buying lottery chances, often called “tickets”. In order to be profitable, lotteries require extremely large numbers of participants purchasing tickets at relatively modest costs to form a large cash flow into the lottery system. Profitability also requires that the odds of winning be extremely slight and therefore a small amount of the money derived is paid back out to winners as prizes or jackpots.

Virtually any game or chance activity may be used to form the basis of a lottery. Many lotteries utilize established games having purchased tickets which are already printed with potentially winning numbers and which employ some obscuring apparatus such as the well known “scratch-off” tickets or the like. Many lottery games also provide the capability for so-called instant winners in which, as the name implies, the player having a winning ticket receives a cash payout immediately. The most significant and perhaps the most common form of lottery is found in the typical number based game. In some instances, a combination of numbers and letters may also be utilized. However, in either case, the principle remains the same in that players desiring to participate in the lottery purchase tickets bearing either numbers or combinations of numbers and letters. Because number based lotteries are the most common, the remainder of this document will refer generally to combinations of numbers rather than letters and numbers. However, it will be apparent to those skilled in the art that the present invention is equally applicable to lotteries based upon numbers as well as lotteries based upon combinations of numbers and letters.

In most lottery systems, the player has the choice of either accepting a randomly generated number combination for a ticket purchased or selecting his or her own choice of numbers to be applied to the purchased ticket. It has been found that, for the most part, player selection of numbers adds an increased level of excitement and interest and therefore is often the most favored or preferred form of lottery participation.

As substantial numbers of tickets are purchased, the tickets are recorded and entered into the system to provide for subsequent validation of winning tickets and to be utilized in calculating the jackpots and prizes. Thus, a portion of each ticket purchase is contributed to the jackpot amount which is typically publicized as the jackpot amount grows in hopes of stimulating further interest by participants. During the time that the lottery runs and tickets are purchased by players, the winning number in most lotteries will not yet have been determined. The winning numbers usually remain indeterminate until at some point lottery ticket purchase is halted and winning numbers are determined by a chance event such as a public drawing or the like. To further interest in lottery participation generally, the common practice in lottery number drawings is to maximize the publicity and excitement created by the drawing itself.

The actual lottery participation by a player varies somewhat in different lottery systems. However, in most lotteries, tickets are purchased at either attended facilities such as stores or other commercial sites or at stand alone units called “kiosks”. Ticket purchase at attended facilities such as stores or other commercial sites is a relatively straight forward transaction in which the player simply purchases one or more tickets, pays the attendant for the tickets and undertakes number selection. The transaction is completed by the attendant entering the selected numbers for the purchased tickets into the system and transferring the lottery tickets to the player. In some instances, the creation of large jackpots in widely publicized lotteries creates a phenomenon known as “lotto fever” in which demand for lottery tickets and the number of players participating surges dramatically leading to long lines at the various purchase sites. As the jackpot continues to swell, these long lines often virtually swamp the host facility and cause substantial congestion within the facility and delay for the players purchasing tickets.

Stand alone lottery kiosk units do not require attendants and thus may at some point become more widely available both as to number of units and operating hours in which they may be accessed. Thus, while lottery kiosks may be placed in the same facilities as attended sites such as stores or other commercial businesses, they may also be placed in additional sites such as malls, building lobbies, filling stations and virtually any other location. As a result, lottery kiosks have the potential of becoming significantly more available to players desiring to purchase tickets than attended purchase sites.

The typical lottery kiosk includes a stand alone cabinet somewhat similar in appearance to a typical arcade video game and includes a display screen, a plurality of user input keys, a ticket printer and dispenser and a money receiver and dispenser. Within the lottery kiosk cabinet, a control unit which is typically microprocessor based manages the display function, runs ticket purchasing activities, dispenses printed tickets and often includes a sound enhancement capability. The purchase process in a typical lottery kiosk is menu driven as a series of images are presented on the display to aide and guide the player through number entry and ticket purchase. The player leaves with one or more purchased tickets usually in printed form. The control apparatus of the kiosk also includes communication apparatus which allows to kiosk to transfer the purchased ticket information to the main lottery system for entry into the system and to record ticket purchases in the event future validation is required.

While some amusement may be provided by the lottery kiosk through the use of creative and attractive images of the display and interesting sounds, the overall process of ticket purchase is often dull, tedious and repetitive. The process of purchasing lottery tickets at attended facilities is usually even more dull and tedious since the attractive images and sound of the lottery kiosk are usually absent from the process. The large numbers of lottery players indicate that there is little doubt that participation in lotteries allows the players to derive some enjoyment, excitement and/or entertainment. It is likely that whatever excitement and entertainment value is found in lottery participation is based primarily upon the attendant hope and potential for winning as well as other similar expectations. However, notwithstanding such emotions derived from overall lottery participation, the process of ticket purchase itself remains sadly uninteresting and is often vexing and tedious.

There arises therefore a continuing and unsatisfied need in the art for more interesting and entertaining apparatus and systems for lottery ticket purchase and lottery participation. In particular, there remains a continuing and unsatisfied need in the art for lottery ticket participation apparatus which encourages the purchase of lottery tickets by the consumer.

### SUMMARY OF THE INVENTION

Accordingly, it is a general object of the present invention to provide improved apparatus and systems for purchasing lottery tickets and participating in lottery activities. It is a more particular object of the present invention to provide an improved lottery kiosk which increases the entertainment and enjoyment of the lottery ticket purchase activity. It is a still more particular object of the present invention to provide an improved lottery kiosk which more significantly involves the player in the ticket generation process and which motivates the player to continue purchasing additional lottery tickets.

In accordance with the present invention there is provided a lottery kiosk comprising: purchase means for player purchase of a lottery ticket; game means for playing a game enhancement integrated into the purchase means; means for receiving player funds and establishing a player credit meter account; and means for player selection of the game means in combination with the purchase means whereby participation in the game makes a player eligible for winning additional lottery tickets.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a lottery kiosk constructed in accordance with the present invention;

FIG. 2 sets forth a block diagram of the present invention lottery kiosk operative systems;

FIG. 3 sets forth a simplified block diagram of the game play flow of the present invention lottery kiosk as seen from the players perspective;

FIGS. 4A and 4B set forth illustrative game screens at different stages of game play utilized by the present invention lottery kiosk;

FIGS. 5A and 5B taken together set forth a flow diagram of the operation of the present invention lottery kiosk.

### DESCRIPTION OF THE PREFERRED EMBODIMENTS

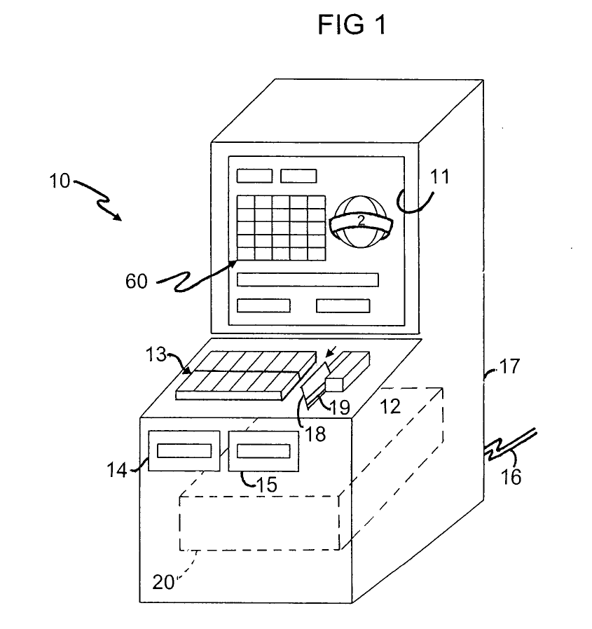

FIG. 1 sets forth a perspective of a lottery kiosk constructed in accordance with the present invention and generally referenced by numeral 10. Lottery kiosk 10 includes a cabinet 17 which supports a display 11. Cabinet 17 further supports a magnetic card reader 12 together with a plurality of user input buttons 13 and a ticket reader 14. A ticket printer 15 is also supported by cabinet 17. Within cabinet 17, a controller 20 constructed in the manner set forth below in greater detail is also supported. While not seen in FIG. 1, it will be apparent to those skilled in the art that controller 20 is operatively coupled to display 11 as well as card reader 12 and user input buttons 13. It will be further apparent to those skilled in the art that controller 20 is operatively coupled to ticket reader 14 and ticket printer 15. An image 60 set forth below in greater detail is displayed upon display 11 under the control of controller 16 as is also described below. In addition, controller 20 is operatively coupled to the main lottery system (not shown) by a communication line 16.

Card reader 12 is fabricated in accordance with conventional fabrication techniques and defines a slot 22 through which a magnetically striped or magnetically encoded user card 18 may be moved to transfer information via card reader 12. In the example shown in FIG. 1, user card 18 supports a magnetic stripe 19 which has been magnetically coded with the user's information. Accordingly, the user moves card 18 through slot 22 of card reader 12 in the direction indicated by arrow 21 to input information to lottery kiosk 10. Similarly, ticket reader 14 and ticket printer 15 are fabricated in accordance with conventional fabrication techniques. Accordingly, ticket reader 14 is able to receive an inserted ticket and to read the information printed thereon. Similarly, printer 15 is operative to print information upon an internally generated ticket within lottery kiosk 10 which is then transferred out to the user. Input buttons 13 provide various input capability for the user by which the user is able to input information to be used by controller 20 in the game and lottery activities set forth below.

In operation, controller 20 manages the performance and operations of display 11 together with card reader 12 and ticket reader 14 and printer 15 to carry forward the basic functions of lottery ticket purchase. In addition, controller 20 provides an image such as image 60 upon display 11 which is utilized in the inventive process for purchasing lottery tickets and participating in the present invention game enhancement. For the user, participation is initially undertaken by obtaining a user card such as user card 18 upon which suitable money credits have been magnetically encoded. In the anticipated and preferred fabrication of the present invention, the user obtains a user card such as card 18 by purchasing a card embossed with credits corresponding to the purchase price paid. Thereafter, the user enters the operation of the present invention lottery kiosk by moving card 18 through slot 22 of card reader 12 in the direction indicated by arrow 21. This process is carried forward in accordance with conventional fabrication techniques by which the money credits magnetically encoded upon user card 18 are read and transferred from the card to the credit meter within controller 20. Once the player has established a credit account upon the credit meter, the user is able to purchase lottery tickets and, in accordance with an important aspect of the present invention, the user is also able to win additional credits and/or lottery tickets by participating in the game enhancement also resident within lottery kiosk 10.

After having established a credit account, the player is then presented with various choices as to one or more lottery games to be played. In such choices, the user responds to images upon display 11 and provides responses using input buttons 13. In a typical lottery which is numbers based, the player proceeds to select numbers for a lottery ticket in the manner described below. In accordance with an important aspect of the present invention following the user's selection of numbers for a lottery ticket, the player is then invited to participate in a game enhancement with the prospect of winning additional lottery tickets and/or credits for further play or lottery ticket purchase.

In the preferred fabrication of the present invention, each round of game play within the game enhancement confirms the purchase of the previously selected lottery ticket. Thus, a cycle takes place in which the user selects numbers for a lottery ticket to be purchased and thereafter enters a round of play on the game enhancement of lottery kiosk 10. Each round of play on the game enhancement confirms the previously selected lottery ticket and debits the player's credit account with the ticket purchase price. Following each round of play on the game enhancement, the player returns to the lottery ticket number selection stage and the process is repeated. At some point, the player may opt to exit the system and discontinue lottery ticket purchase and game play as desired. In such case, the player's lottery tickets previously purchased and credit account is printed upon a lottery ticket received from printer 15. In the event the player continues participation in the lottery purchase and game play activities until the conclusion of game play, the player's purchased lottery tickets together with any additional lottery tickets or credits won by the player in playing the game are printed using printer 15 and provided to the player.

In accordance with an important aspect of the present invention, the integration of a game enhancement within the lottery ticket purchase provided by the present invention lottery kiosk serves to greatly increase the entertainment and amusement value of the lottery ticket purchase process. In accordance with a further important advantage of the present invention lottery kiosk, the potential winnings provided by the integrated game of the present invention lottery kiosk and its game play within the lottery ticket purchasing process motivates the typical player to continue participation and purchase or otherwise acquire additional lottery tickets.

It will be apparent to those skilled in the art that the advantages set forth herein which the present invention lottery kiosk and its integrated game enhancement provide may be realized utilizing a variety of different game enhancements. Thus, the present invention lottery kiosk will be understood to accommodate a variety of enhancing games without departing from the spirit and scope of the present invention. In accordance with the illustrative game embodiment set forth below in greater detail, it has been found that game enhancements having multiple successive rounds of play activity are particularly well suited to the present invention. However, the present invention is not limited to any particular or specific game enhancement.

As a result, the player is able to undertake the purchase of a single lottery ticket or a plurality of lottery tickets in an amusing and entertaining game play environment. This represents a substantial improvement over the often tedious and dull lottery kiosk activities presently available. In addition, the interest and enjoyment of game play together with the potential for winning additional credits for subsequent play or lottery ticket purchase or direct winning of additional lottery tickets greatly motivates the player and results in increased lottery ticket purchase. The present invention lottery kiosk therefore provides improved game play and winning potential for the player as well as increased income and lottery play activity for the host lottery system.

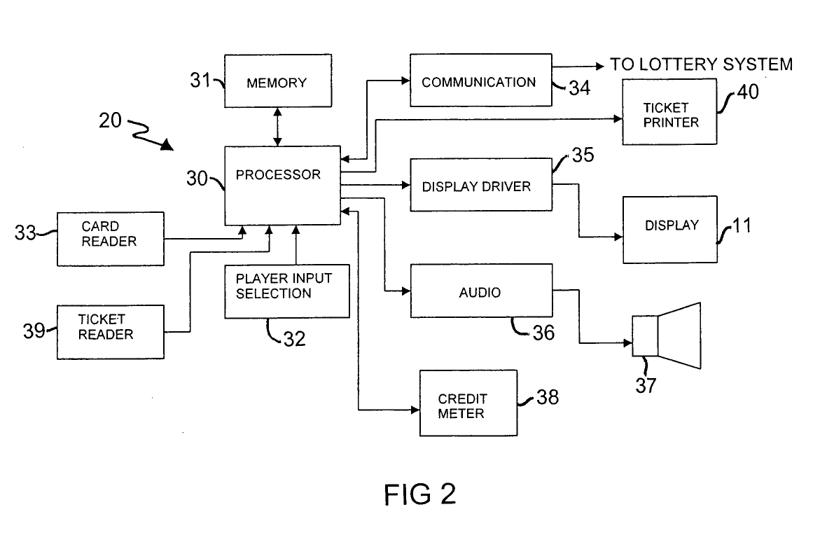

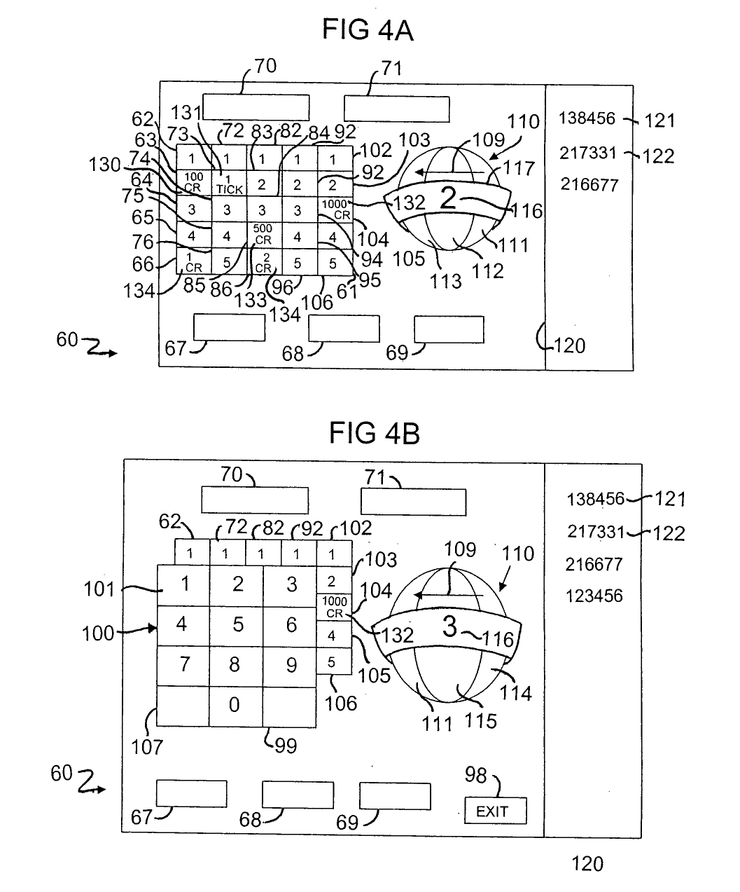

FIG. 2 sets forth a block diagram of control unit 20 utilized within lottery kiosk 10. Control unit 20 is fabricated in accordance with conventional fabrication techniques typical of digital electronic control apparatus. Accordingly, control unit 20 includes a processor 30 which, may for example, comprise a conventional micro processor of the type readily available in the art. Control unit 20 further includes a memory 31 operatively coupled to processor 30 together with a player input and selection apparatus 32 also coupled to processor 30. Player input selection apparatus 32 is representative of a variety of player input selection devices such as the above mentioned dedicated input buttons, 13 as well as touch screen input apparatus (described below in FIG. 4B). Control unit 20 further includes a conventional magnetic card reader 33 which allows processor 30 to establish and maintain a player's credit account within a credit meter 38. Control unit 30 further includes a display driver 35 operatively coupled to a video display unit 11. Display unit 11 operates to provide video displays such as game image 60 (seen in FIG. 1). In addition, control unit 20 includes a conventional audio system 36 operatively controlled by processor 30 and coupled to a suitable output device such as speaker 37. A ticket reader 39 is operatively coupled to processor 30 and allows information to be transferred to processor 30 from an inserted ticket. Conversely, a ticket printer 40 also operatively coupled to processor 30 is used to print purchased lottery tickets and credit account status.

In operation, processor 30 cooperates with the stored software within memory 31 to carry forward the lottery ticket purchase activity and play of the game enhancement of the present invention lottery kiosk described below in greater detail. In carrying forward both ticket purchase and game play, processor 30 responds to player input selections via input selection unit 32 and the touch screen described below in FIG. 4B. Credit meter 38 is utilized under processor control to establish and maintain credit account of the player during the course of one or more lottery ticket purchase and rounds of game play. Finally, processor 30 utilizing the stored instruction set within memory 31 operates display driver 35 to provide appropriate images during lottery ticket purchase and game play upon display 11 and operates audio system 36 to provide appropriate sounds to further enhance lottery ticket purchase and game play appeal. In addition, communication unit 34 operates to communicate between lottery kiosk 10 and the remainder of the master lottery system.

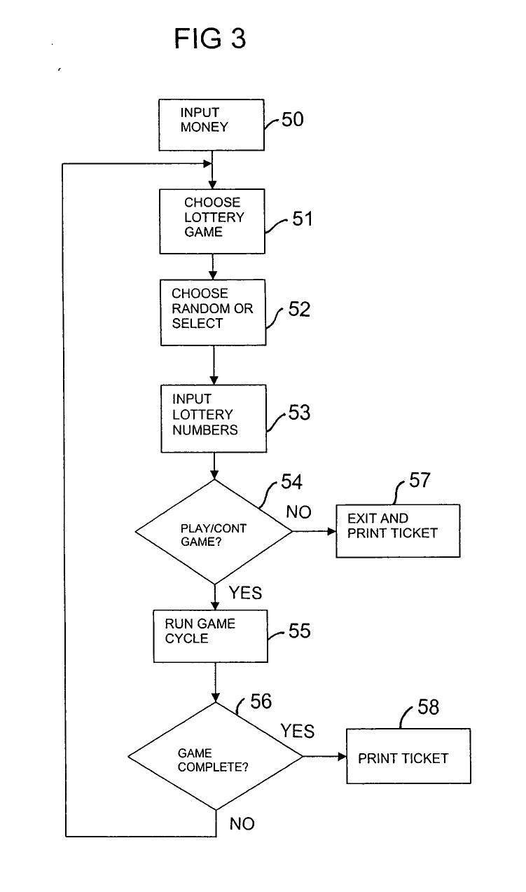

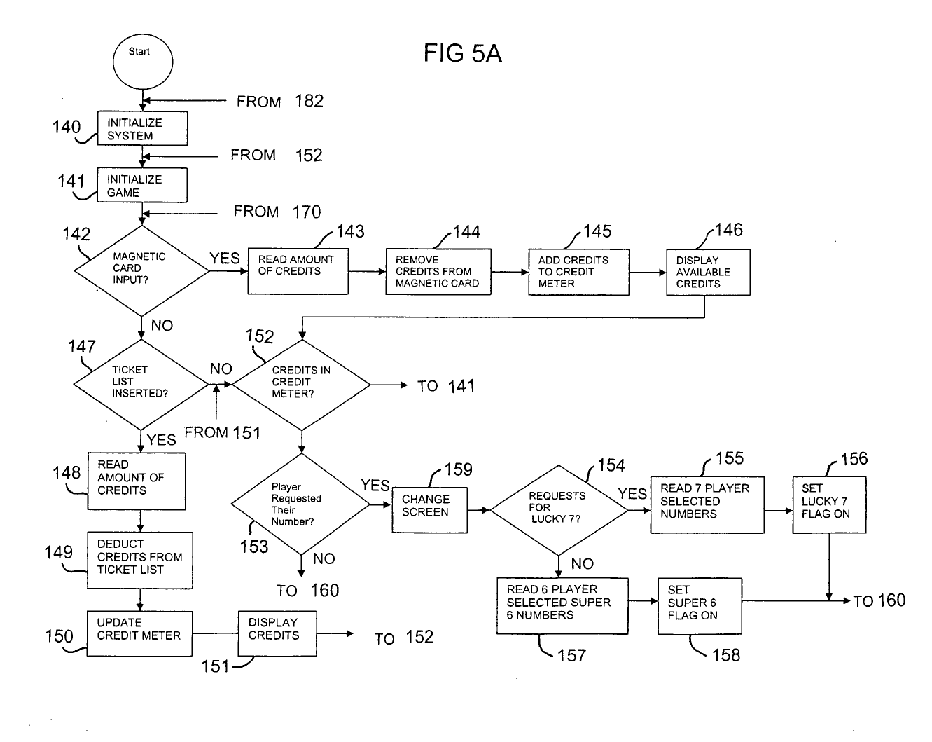

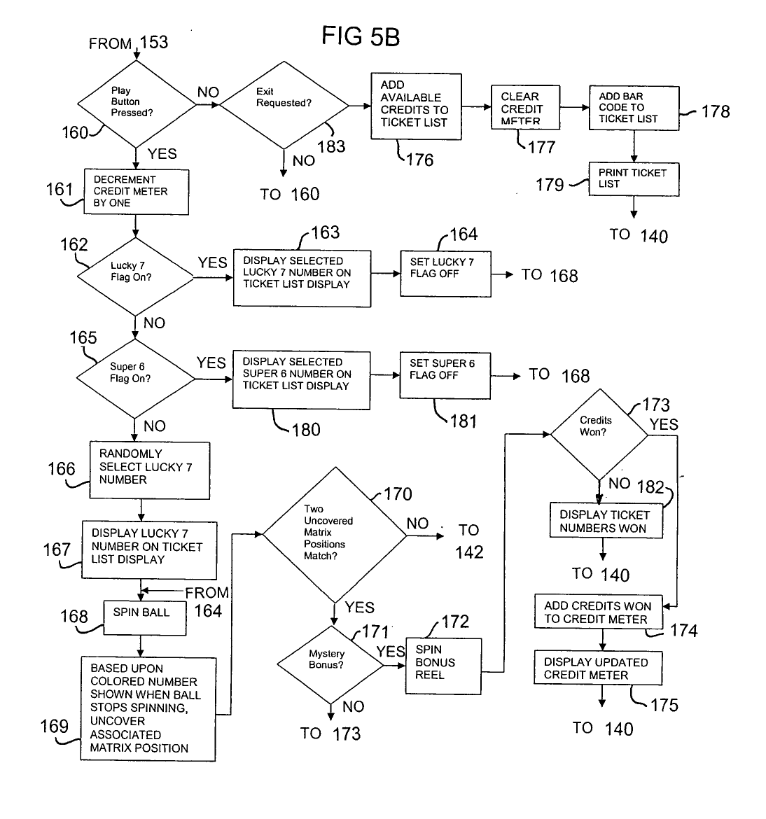

FIG. 3 sets forth a basic flow diagram of the present invention lottery kiosk operation as seen from the players perspective. It will be noted that a more detailed flow diagram of the operation of the present invention lottery kiosk is set forth below in FIG. 5A and 5B. Returning to FIG. 3, at step 50, the player inputs sufficient funds to initiate and carry forward the purchase of one or more lottery tickets. It will be noted that the transfer of funds to the credit account of the player within the present invention lottery kiosk may be carried forward using a magnetic card in cooperation with card reader 12 (seen in FIG. 1) or alternatively may be established by inserting a ticket having credits printed thereon into ticket reader 14 (also seen in FIG. 1). The import aspect with respect to the present invention game play is the transfer of funds to the lottery kiosk system. Thereafter, the player chooses from available lottery games at step 51 and at step 52 determines whether the user chooses to select lottery ticket numbers or to allow the system to randomly generate lottery ticket numbers. It has been found that in most instances, players prefer to create their own lottery ticket numbers. In any event, once at step 52 the player has selected the desired lottery ticket numbers, the player then utilizes the input buttons or touch screen apparatus within lottery kiosk 20 to input the desired numbers. It will be noted with temporary reference to FIG. 4B that in the preferred fabrication of the present invention, the selected and inputted numbers appear upon the image display in a convenient manner. Thereafter, the player determines whether to exit the system at step 57 causing the printing of the lotto ticket or tickets previously selected. Alternatively, and in accordance with the present invention, the player may elect at step 54 to play a round of the game enhancement. Upon entering the game enhancement, the lottery number selected at step 53 is entered into the lottery system and the players credit account is debited by the appropriate purchase price. At step 55, a cycle of the game play is run and the player observes the display screen image (such as image 60 shown in FIG. 4A) for game play results. At step 56, the player is provided with an indication as to whether the game enhancement has completed a game. If the game is completed, the system moves to step 58 and the player is provided with a printed ticket listing the lottery ticket purchased as well as credit remaining. In addition and in accordance with an important aspect of the present invention, the game play winnings within a given game enhancement may include one or more lottery tickets. In such case, the lottery tickets won during game play also are printed out at the ticket at step 58 upon completion of the game enhancement.

In the event at step 56 the game is not complete by the previous cycle at step 55, the user returns to step 51 and again chooses the desired lotto game to be played. Thereafter, the above described play process repeats with the player selecting a lotto ticket number or allowing random choice by the system after which the selected numbers are inputted to the lottery kiosk at step 53 and a decision is made as to whether the player desired to exit the ticket purchase and game play process at step 57 or again participate in a cycle of game play which is run at step 55. Once again, at step 56, a determination is made as to whether the game is complete and the player either exits to step 58 as a result of game completion or in the absence of a completed game once again returns to step 51.

The process set forth in FIG. 3 is carried forward on a repeated basis until either the player elects to exit the system to step 57 rather than initiate the next cycle of game play or until completion of the game enhancement occurs and the system moves automatically to step 58 printing out lottery tickets and remaining credits. In the example set forth below for the game enhancement described in FIGS. 4A, 4B together with FIGS. 5A and 5B, a game is completed by the occurrence of an icon match within the number matrix. It will be apparent to those skilled in the art however that a virtually endless variety of game enhancements may be played at steps 54, 55 and 56 in the game play flow shown in FIG. 3 without departing from the spirit and scope of the present invention. In accordance with an important aspect of the present invention, the integration of a game enhancement within the lottery ticket purchase process greatly expands the appreciation, enjoyment and excitement of lottery ticket purchase. In addition and in further accordance with advantages of the present invention, the player is often stimulated and motivated by the game enhancement integrated into lottery ticket purchase to undertake a greater number of lottery ticket purchases as the player cycles through ticket purchase and game play cycles.

FIGS. 4A and 4B set forth display images utilized in the game enhancement shown in the embodiment of FIGS. 5A and 5B. Once again, it will be understood that the game enhancement or game play which is described in the present embodiment and shown in FIGS. 4A, 4B, 5A and 5B is merely illustrative of the present invention and is not limiting as to the spirit and scope thereof. By way of further overview, FIG. 4A sets forth the imaged displayed during game play cycles and initiation of game play while FIG. 4B sets forth the altered image displayed during the operation in which the player inputs selected numbers for the current lottery ticket.

More specifically, an image display 60 appearing upon display 11 includes a five row and five column matrix of squares in which each column of the matrix defines a characteristic number distinct from the remaining matrix columns. In addition, each column within matrix 61 is numbered one through five with the upper most number being one and the lower most number being five. Thus, squares 62 through 66 forming the first column matrix 61 are numbered one through five respectively. Similarly, squares 72 through 76 of the next column of matrix 61 are numbered one through five respectively. In the same manner, squares 82 through 86 and 92 through 96 as well as 102 through 106 of matrix 61 are respectively numbered one through five. In addition, the numerals of squares 62 though 66 are blue in color while the numerals on squares 72 through 76 are purple in color and numerals 82 through 86 are red in color. Further, the numerals on squares 92 through 96 are orange in color while the numerals on squares 102 through 106 are yellow in color. It will be recognized that the arrangement and selection of colors within matrix 61 is to some extent a matter of design choice. However, as will be described below in greater detail, the use of characteristic colors for each of the columns within Matrix 61 forms a portion of the square identification within the matrix.

Image 60 further includes a rotating numbered ball 110 which is encircled by an opaque band 115. Opaque band 115 displays a numeral 116 which is transparent allowing the portion of number ball 110 directly beneath numeral 116 to be seen. Numbered ball 110 is divided into segments 111, 112, 113, 114 and 115. In addition, image 60 includes a credit display 67 together with lottery game score displays 68 and 69 as well as current lottery jackpot displays 70 and 71.

Image 60 further includes a ticket column 120 within which a plurality of previously purchased lottery ticket numbers 121 and 122 are shown.

During the initialization of the game enhancement set forth in FIGS. 4A, 4B, 5A and 5B, a plurality of winning icons are randomly distributed in accordance with the squares of matrix 61. During the initialization of the game described below, each square of matrix 61 is provided with a latent icon which remains invisible beneath its respective square numeral until the game play of numbered ball 110 and numeral 116 of band 115 coincides with that particular matrix square. When the numeral and color indicated by numbered ball 110 and numeral 116 during the game play described below identifies a given square within matrix 61, the underlying latent icon is then visible.

In the preferred fabrication of the present invention game enhancement, a total of nineteen winning icons are utilized which are randomly distributed without duplication under nineteen of the twenty five squares forming matrix 61. Thereafter, the remaining six squares are 10 given latent icons randomly selected from the nineteen icons without duplication. As a result, there are six duplicate possibilities of icons within the twenty five squares forming matrix 61. In the embodiment of the present invention game, the winning icons selected consist of the following:
Win 2 Credits
Win 3 Credits
Win 5 Credits
Win 10 Credits
Win 20 Credits
Win 100 Credits
Win 200 Credits
Win 1000 Credits
Win 1 Lucky 7 Lottery Ticket
Win 2 Lucky 7 Lottery Tickets
Win 3 Lucky 7 Lottery Tickets
Win 5 Lucky 7 Lottery Tickets
Win 10 Lucky 7 Lottery Tickets
Win 1 Super 6 Lottery Tickets
Win 2 Super 6 Lottery Tickets
Win 3 Super 6 Lottery Tickets
Win 5 Super 6 Lottery Tickets
Win 10 Super 6 Lottery Tickets
Mystery Bonus

With the understanding of image 60 shown in FIG. 4A, the game play operation of the game enhancement may now be understood. It will be recalled by temporary return to FIG. 3 that the player initially chooses the lottery for participation and thereafter selects a lottery ticket number which in inputted to the lottery system for ticket purchase. It will be recalled that this operation is carried forward by the player in steps 51, 52 and 53 of FIG. 3. To facilitate number selection and input for lottery ticket purchase, image 60 is altered during the number selection and input process to the image shown in FIG. 4B. By way of overview, image 60 shown in FIG. 4B differs from image 60 shown in FIG. 4A solely in the insertion of a touch screen number pad 100 which occupies a portion of the display image.

More specifically, an image display 60 appearing upon display 11 includes a five row and five column matrix of squares in which each column of the matrix defines a characteristic number distinct from the remaining matrix columns. In addition, each column within matrix 61 is numbered one through five with the upper most number being one and the lower most number being five. Thus, squares 62 through 66 forming the first column matrix 61 are numbered one through five respectively. Similarly, squares 72 through 76 of the next column of matrix 61 are numbered one through five respectively. In the same manner, squares 82 through 86 and 92 through 96 as well as 102 through 106 of matrix 61 are respectively numbered one through five. In addition, the numerals of squares 62 though 66 are blue in color while the numerals on squares 72 through 76 are purple in color and numerals 82 through 86 are red in color. Further, the numerals on squares 92 through 96 are orange in color while the numerals on squares 102 through 106 are yellow in color. It will be recognized that the arrangement and selection of colors within matrix 61 is to some extent a matter of design choice. However, as will be described below in greater detail, the use of characteristic colors for each of the columns within Matrix 61 forms a portion of the square identification within the matrix.

Image 60 further includes a rotating numbered ball 110 which is encircled by an opaque band 115. Opaque band 115 displays a numeral 116 which is transparent allowing the portion of number ball 110 directly beneath numeral 116 to be seen. Numbered ball 110 is divided into segments 111, 112, 113, 114 and 115. In addition, image 60 includes a credit display 67 together with lottery game score displays 68 and 69 as well as current lottery jackpot displays 70 and 71.

Image 60 further includes a ticket column 120 within which a plurality of previously purchased lottery ticket numbers 121 and 122 are shown.

Touch screen pad 100 is fabricated in accordance with conventional fabrication techniques and includes a plurality of number squares of touch pads 101. Touch pads 101 are conventional in arrangement and support respective numbers one through nine and zero. In addition, touch pad 100 includes a random number option pad 107. The latter may be utilized to choose a random number lottery ticket selection by the processor within the lottery kiosk rather than number selection by the player. Thus, as the player enters the selected lottery game, the altered image of FIG. 4B appears on display 11 allowing the player to select either random number generation or allowing the player to input the desired number choice for the current lottery ticket. By way of example, and for illustration purposes, it is assumed in FIG. 4B that the user has employed touch screen pad 100 to select numbers one, two, three, four, five and six. The selected numbers now appear in ticket column 120 as the latest selected lottery ticket numbers. Once the numbers for the current lottery ticket have been selected an inputted using touch screen pad 100, the player may exit the system and purchase the lottery ticket by touching exit pad 98. Alternatively, there may also be provided a dedicated exit button among player input buttons (seen in FIG. 1). If however the player elects to initiate a cycle of game play, the player touches play pad 99 of touch screen pad 100 causing the lottery kiosk to initiate a cycle of game play. The cycle of game play is entered as the character of image 60 returns to the image shown in FIG. 4A.

With the above initialization having taken place and with the new lottery ticket number being entered into ticket column 120, the image of FIG. 4A remains during the game play cycle. Game play commences as numbered ball 110 rotates in the direction indicated by arrow 109 and transparent numeral 116 randomly cycles through numbers one through five. Once the rotation of numbered ball 110 terminates, the position of numbered ball 110 places one of segments 111 through 115 directly beneath transparent numeral 116 of band 115. In accordance with the preferred fabrication of the present invention, the colors of segments of 111 through 115 correspond to the characteristic colors of each of the vertical columns in matrix 61. Thus, for example, segment 111 may be blue in color while segment 112 is purple and segment 113 is red. Accordingly, 114 may be orange while segment 115 may be yellow. Thus, the stop position of numbered ball 110 which is controlled by the random number generation apparatus within the kiosk controller selects the color of transparent numeral 116. Correspondingly, the random number generation of numeral 116 randomly selects numeral 116 from the range of numbers one through five. In the example shown in FIG. 4A, segment 112 which may for example, be purple in color, is positioned beneath numeral 116 and numeral 116 has stopped at the number two. Accordingly, numbered ball 110 has randomly selected a numeral two having a purple color. Examination of matrix 61 reveals that this selection corresponds to square 73. The selection of square 73 causes the numeral two thereon to be replaced with its underlying latent winning icon. For purposes of illustration, the winning icon beneath square 73 is now revealed as win one lottery ticket. At this point, the newly revealed icon is compared to the previously revealed icons from either rounds of play. In the example of FIG. 4A, squares 63, 66, 85, 86 and 104 have been previously revealed. However, no match in revealed icons is produced by revealing the icon from square 73. Thus, the game has not yet been completed and the player may elect to either exit the system and receive the previously selected and purchased lottery tickets shown in column 120 or alternatively the player may return to step 51 shown in FIG. 3 and select another lottery ticket for purchase and once again go through a cycle of game play.

The player may exit the system at any time following the completion of a round of game play. In addition, the cycles of game play and ticket purchase may continue with successive icons being revealed in matrix 61 until a match occurs. Once a round of game play results in a match of revealed icons, the game is ended and the player automatically exits the game. It will be recalled from FIG. 3 that this exit process includes printing a ticket which indicates credits remaining, lottery tickets purchased, together with lottery tickets won, if any, during game play. The player may utilize remaining credits to continue game play be inserting the printed ticket into ticket reader 14 (shown in FIG. 1).

In the preferred fabrication of the present invention, separate tickets are printed for each lottery game played. This allows the player to play each lottery game independently once the tickets have been printed by the system. This also accommodates different timing between different lottery games. For example, if the present invention lottery kiosk permits a player to participate in either or both a daily game such as 7/70 and a weekly game such as 6/49, the player upon completion of ticket purchase and game play will receive two ticket certificates. One certificate bears tickets (both purchased and won) for the daily game while the remaining certificate bears tickets (both purchased and won) for the weekly game. If more than two lotteries are available, a corresponding number of ticket certificates are printed each having tickets of a given lottery type.

FIGS. 5A and 5B taken together set forth the operational flow diagram of the present invention lottery kiosk with particular attention to controller 20 (seen in FIG. 1). With particular attention to FIG. 5A, at step 140, the system initializes and goes through a typical initializing process in which the system is on-line with the main lottery system and is identified to the system. In essence, the system signs on and goes through the process of preparing for lottery ticket purchase and game play. At step 141, the game enhancement portion of the system is initialized and steps such as clearing of all registers, returning the game display to its start condition, and setting up random number generation and matrix icons are carried forward. Thereafter, at step 142, a determination is made as to whether a magnetic card input from a player has been sensed. If a magnetic card input is sensed, the system moves to step 143 reading the amount of credits thereon after which at step 144, the credits from the magnetic card are removed. At step 145, the credits from the magnetic card are added to the credit meter and displayed as available credits at step 146.

At step 152, a determination is made as to whether the credit meter shows a positive balance of credits. If not, the system moves to step 141 and again awaits game initializing. If however credits exists in the credit meter, the system moves to step 153 in which a determination is made as to whether the player has requested number selection. If number selection is not requested, the system moves to step 160 (seen in FIG. 5B). If however the player has requested number selection, the system moves to step 159 presenting the touch screen image shown in FIG. 4B. Thereafter, a determination is made at step 154 as to whether the lottery game “Lucky 7” has been chosen. If Lucky 7 has been chosen, the system moves to step 155 reading the seven selected numbers inputted by the player. Thereafter, at step 156, the Lucky 7 flag is set to on and the system moves to step 160.

If however at step 154 a determination is made that Lucky 7 has not been requested, the system moves to step 157 in which it is assumed that the alternate lottery game of Super 6 is to be played. The numbers inputted by the player at step 159 are then read at step 157 and at step 158 the Super 6 flag is set to on. Thereafter, the system moves to step 160 (seen in FIG. 5B).

If at step 142 a determination is made that magnetic card input has not been received, the system moves to step 147 and determines whether a ticket list has been inserted into the ticket reader. If the ticket reader has not received an inserted ticket, the system moves to step 152 and continues as described above. If however, a ticket has been inserted, the amount of credits remaining is read at step 148 and at step 149 the credits on the inserted ticket are deducted. At step 150, the credit meter is updated to reflect the credits transferred from the inserted ticket and thereafter the available credits are displayed at step 151. Following step 151, the system moves to step 152 and thereafter as described above.

With reference to FIG. 5B, the system moves from step 153 to step 160 in which a determination is made as to whether the play button indicating a desire by the player to enter a round of game play has been pressed. If the play button has not been pressed, the system moves to step 183 at which a determination is made as to whether the player has requested exit. In the event exit has not been requested, the system returns to step 160. If however, the player has requested exit, the system moves to step 176 at which the available credits are added to the players ticket list. The players credit meter is cleared at step 177 and at step 178 a bar code indicative of the players credit meter balance is added to the ticket list. Thereafter, at step 179, the ticket list having the players credit account balance bar code thereon.

In the preferred fabrication of the present invention, the ticket list printed at step 179 I sorted by lottery game type such that each certificate printed bears one type of lottery game tickets. Multiple certificates (one for each lottery type) are printed at step 179.

If however a determination is made at step 160 that the play button has been pressed, the system moves to step 161 and the players credit meter is decremented by one credit. At step 162, a determination is made as to whether the Lucky 7 flag is set to on. If the Lucky 7 flag is on, the system moves to steps 163 and 164 displaying the Lucky 7 number ticket list display and setting the Lucky 7 flag to off. Thereafter, the system moves to step 168. If at step 162 the Lucky 7 flag is not set to on, a determination is made at step 165 as to whether the Super 6 flag is set to on. If the Super 6 flag is on, the system moves through steps 180 and 181 in which the Super 6 number selected by the player is displayed on the ticket list display and the Super 6 flag is set to off. Thereafter, the system moves to step 168.

If at step 165 a determination is made that the Super 6 flag is not set to on, the system randomly selects a Lucky 7 ticket number at step 166. In essence, this provides that in the absence of a lottery choice by the player the Lucky 7 lottery game is selected by default with a random number ticket selection. At step 167, the random number is displayed on the ticket list and at step 168, the numbered ball spin game play cycle described above is undertaken. At step 169, the random number and its color present when the numbered ball stops spinning is determined and utilized in uncovering the associated icon beneath the corresponding matrix square as described above in FIG. 4A. Thereafter, the system moves to step 170 at which a determination is made as to whether the uncovered matrix icon matches any previously uncovered icon. If not, the system moves to step 142 (seen in FIG. 5A). If however a match is found, the system moves to step 171 at which a determination is made as to whether a mystery bonus icon match has occurred. It will be noted that if a match is detected at step 170, game play is complete and the user is no longer able to continue cycling through game play. If no mystery bonus icon match is found at step 171, the system moves to step 173. If however a mystery bonus icon is detected, the system moves through step 172 in which a bonus spin is undertaken. The bonus spin is a supplementary chance game of any type which provides a further modification of credit winnings in a completed game if the matched icons are the mystery bonus icons. At step 173, a determination is made as to whether any credits have been won by the player during game play. If credits have been won, the system moves to step 174 adding the credits won to the players credit account within the credit meter. Thereafter, at step 175, the updated credit meter amount is displayed and the system returns to step 140.

If however credits have not been won at step 173, the system moves directly to step 182 displaying the ticket numbers won, if any, and thereafter moves to step 140.

It will be apparent to those skilled in the art that the game enhancement described with great particularity in FIGS. 4A, 4b, 5A and 5B is particularly well suited to the present invention game enhancement function. However, it will be equally apparent to those skilled in the art that a variety of games having varying suitability and advantage for use as the game enhancement within the present invention lottery kiosk may be selected without departing from the spirit and scope of the present invention.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

1. A lottery kiosk comprising:
purchase means for player purchase of a lottery ticket;
game means for playing a game enhancement integrated into said purchase means;
means for receiving player funds and establishing a player credit meter account; and
means for player selection of said game means in combination with said purchase means whereby participation in said game makes a player eligible for winning additional lottery tickets.

2. The lottery kiosk set forth in claim 1 wherein said purchase means includes means for selecting between alternative lottery games.

3. The lottery kiosk set forth in claim 2 wherein said purchase means includes means for selecting numbers of purchased lottery tickets.

4. The lottery kiosk set forth in claim 1 wherein said purchase means includes means for selecting number of purchased lottery tickets.

5. The lottery kiosk set forth in claim 4 wherein said game means game enhancement includes a multiple cycle game and wherein said purchase means precedes each cycle of said game by a lottery ticket purchase.

6. The lottery kiosk set forth in claim 5 wherein same game further includes winning events which increase a player credit meter account.

7. The lottery kiosk set forth in claim 6 wherein said purchase means includes means for recording purchased lottery tickets.

8. The lottery kiosk set forth in claim 7 wherein said purchase means includes exit means operative following a lottery ticket purchase for exiting said lottery kiosk without further use of said game means.

9. The lottery kiosk set forth in claim 8 wherein said means for receiving player funds includes a magnetic card reader.

10. The lottery kiosk set forth in claim 8 wherein said means for receiving includes a ticket reader.

11. The lottery kiosk set forth in claim 2 wherein said purchase means includes means for printing certificates having lottery tickets purchased, or won during participation in said game means, thereon.

12. The lottery kiosk set forth in claim 11 wherein said purchase means includes means for printing separate certificates bearing lottery tickets for one of each of said alternative lottery games thereon.
